(19) United States
(12) Patent Application Publication
(10) Pub. No.: US 2026/0343507 A1
(43) Pub. Date: Oct. 29, 2026

(54) COMMUNICATION METHOD AND COMMUNICATION APPARATUS

(71) Applicant: HUAWEI TECHNOLOGIES CO., LTD., Shenzhen (CN)

(72) Inventors: Zhiheng Guo, Beijing (CN); Hailong Hou, Beijing (CN); Xinghua Song, Beijing (CN)

(73) Assignee: HUAWEI TECHNOLOGIES CO., LTD., Shenzhen (CN)

(21) Appl. No.: 19/710,831

(22) Filed: Jun. 17, 2026

Related U.S. Application Data
(63) Continuation of application No. PCT/CN2024/128316, filed on Oct. 30, 2024.

(30) Foreign Application Priority Data
Dec. 20, 2023 (CN) 202311758083.6

(51) Int. Cl. H04W 72/0453; H04W 72/0446

(52) U.S. Cl. CPC H04W 72/0453; H04W 72/0446

(57) ABSTRACT

A communication method and apparatus. The method includes: sending a first synchronization signal/physical broadcast channel block SSB on a first time-frequency resource; and sending a second SSB on a second time-frequency resource, where the first SSB and the second SSB belong to a first synchronization signal SS burst set, the first time-frequency resource includes a first time-domain resource and a first frequency-domain resource, the second time-frequency resource includes a second time-domain resource and a second frequency-domain resource, the first time-domain resource is the same as the second time-domain resource, and the first frequency-domain resource is different from the second frequency-domain resource.

### CROSS-REFERENCE TO RELATED APPLICATIONS

This application is a continuation of International Application No. PCT/CN2024/128316, filed on Oct. 30, 2024, which claims priority to Chinese Patent Application No. 202311758083.6, filed on Dec. 20, 2023. The disclosures of the aforementioned applications are hereby incorporated by reference in their entireties.

### TECHNICAL FIELD

The embodiments relate to the communication field, a communication method, and a communication apparatus.

### BACKGROUND

In a new radio (NR) system, during access to a base station, a terminal performs time and frequency synchronization with the base station and obtains broadcast information through a synchronization signal/physical broadcast channel block (SSB). To improve coverage performance of the SSB, the base station repeatedly transmits the SSB in different directions on different beams. In a beam direction, a received power of the SSB at the terminal can be higher due to a higher concentration of energy, thereby improving the coverage performance of the SSB. An SSB set in one beam sweep is referred to as a synchronization signal (SS) burst set.

A maximum quantity of SSBs in an SS burst set varies across different frequency bands. For frequency bands below 3 gigahertz (GHz), an SS burst set includes a maximum of four SSBs. For frequency bands between 3 GHz and 6 GHZ, an SS burst set includes a maximum of eight SSBs. However, at higher frequencies such as 6 GHz and the like, more broadcast beams are used for cell coverage, where one SSB is sent on one broadcast beam for access by a terminal. Currently, the defined quantity of SSBs in an SS burst set is improper. Therefore, the maximum quantity of SSBs in an SS burst set may become an urgent problem.

### SUMMARY

The embodiments provide a communication method, which expands a quantity of SSBs included in an SS burst set to increase a quantity of SSBs in a cell, thereby providing synchronization resources for more broadcast beams.

According to a first aspect, a communication method is provided. The method may be performed by a network device, or may be performed by a chip, a circuit, or the like. This is not limited.

The communication method includes: sending a first synchronization signal/physical broadcast channel block SSB on a first time-frequency resource; and sending a second SSB on a second time-frequency resource, where the first SSB and the second SSB belong to a first synchronization signal SS burst set, the first time-frequency resource includes a first time-domain resource and a first frequency-domain resource, the second time-frequency resource includes a second time-domain resource and a second frequency-domain resource, the first time-domain resource is the same as the second time-domain resource, and the first frequency-domain resource is different from the second frequency-domain resource.

In an example in which an entity for performing the communication method is a network device, after determining time-frequency resources respectively corresponding to a plurality of SSBs included in the first SS burst set, the network device may send the SSBs on the corresponding time-frequency resources. The plurality of SSBs in the first SS burst set may include the first SSB and the second SSB, the time-domain resource of the first time-frequency resource corresponding to the first SSB is the same as the time-domain resource of the second time-frequency resource corresponding to the second SSB, and the frequency-domain resource of the first time-frequency resource is different from the frequency-domain resource of the second time-frequency resource. A plurality of SSBs can be sent on a same time-domain resource, SSB transmission is implemented in a frequency division manner. In this way, a quantity of SSBs in an SS burst set is expanded, thereby providing more SSBs and increasing a quantity of SSBs in a cell. As a result, synchronization resources can be provided for more broadcast beams, thereby achieving an enhanced cell coverage capability.

With reference to the first aspect, the method further includes: sending a third SSB on a third time-frequency resource; and sending a fourth SSB on a fourth time-frequency resource, where the third SSB and the fourth SSB belong to the first synchronization signal burst set, the third time-frequency resource includes a third time-domain resource and a third frequency-domain resource, the fourth time-frequency resource includes a fourth time-domain resource and a fourth frequency-domain resource, the third time-domain resource is the same as the fourth time-domain resource, and the third frequency-domain resource is different from the fourth frequency-domain resource.

The first SS burst set further includes the third SSB and the fourth SSB. Transmission of the third SSB and the fourth SSB and transmission of the first SSB and the second SSB are performed in a time division manner. In other words, the time-domain resources corresponding to the third SSB and the fourth SSB are different from the time-domain resources corresponding to the first SSB and the second SSB. A plurality of SSBs may be transmitted in a time division manner, thereby improving backward compatibility.

With reference to the first aspect, the first time-domain resource is a first orthogonal frequency division multiplexing (OFDM) symbol, and the first orthogonal frequency division multiplexing symbol is in a first slot.

With reference to the first aspect, the third time-domain resource is a second orthogonal frequency division multiplexing OFDM symbol, and the second orthogonal frequency division multiplexing symbol is in the first slot.

SSBs on a same time-domain resource may be on a same OFDM symbol. For example, the time-domain resource of the first time-frequency resource corresponding to the first SSB and the time-domain resource of the second time-frequency resource corresponding to the second SSB may be the first OFDM symbol in the first slot. An existing time unit granularity corresponding to a time-domain resource of an SSB may be reused, thereby eliminating a need to define a new time unit granularity. This reduces complexity.

With reference to the first aspect, the first SSB includes a first physical broadcast channel PBCH, the second SSB includes a second PBCH, the first PBCH corresponds to a first demodulation reference signal DMRS sequence, the second PBCH corresponds to a second DMRS sequence, and the first DMRS sequence is the same as the second DMRS sequence.

DMRS sequences corresponding to PBCHs of SSBs on a same time-domain resource may be the same, thereby eliminating different DMRS sequences for the PBCHs of the SSBs on the same time-domain resource. This reduces resource overheads of determining the DMRS sequences.

With reference to the first aspect, the first SSB includes the first physical broadcast channel PBCH, the second SSB includes the second PBCH, the first PBCH includes first indication information, the second PBCH includes second indication information, the first indication information indicates the first SSB, and the second indication information indicates the second SSB.

SSBs on a same time-domain resource are distinguished by indication information carried in PBCHs, so that the terminal device can identify the SSBs based on the indication information carried in the PBCHs in the SSBs. For example, when a 5G terminal device and a terminal device in a future communication system share a spectrum, the 5G terminal device and the terminal device in the future communication system can identify SSBs based on indication information in PBCHs and determine corresponding deployed SSBs, thereby eliminating a need to deploy respective SSB signals. This reduces common overheads of a cell, and improves spectrum utilization.

With reference to the first aspect, the first indication information includes a first index, the first index indicates the first SSB, the second indication information includes a second index, and the second index indicates the second SSB.

With reference to the first aspect, the first indication information is indicated by a first bit in the first PBCH, the second indication information is indicated by a second bit in the second PBCH, a value of the first bit is different from a value of the second bit, the first bit includes at least one bit, and the second bit includes at least one bit.

With reference to the first aspect, the first bit is in a first field in the first PBCH, the second bit is in a second field in the second PBCH, the first field includes a choice field or a reserved field of the first PBCH, and the second field includes a choice field or a reserved field of the second PBCH.

The indication information used to distinguish between the SSBs on the same time-domain resource may be at least one bit in a field in the PBCH. The field in the PBCH includes, but is not limited to, a choice field, a spare field, a reserved field, or the like in the PBCH. In other words, information indicating the SSB may be carried in different fields in the PBCH, thereby improving flexibility.

With reference to the first aspect, the first synchronization signal burst set includes 16 SSBs, the 16 SSBs are sequentially numbered from 0 to 15, and frequency-domain resource of resources corresponding to two SSBs with a number difference of 8 are the same.

According to a second aspect, a communication method is provided. The method may be performed by a terminal device, or may be performed by a chip, a circuit, or the like. This is not limited.

The communication method includes: receiving a first synchronization signal/physical broadcast channel block SSB on a first time-frequency resource; and receiving a second SSB on a second time-frequency resource, where the first SSB and the second SSB belong to a first synchronization signal SS burst set, the first time-frequency resource includes a first time-domain resource and a first frequency-domain resource, the second time-frequency resource includes a second time-domain resource and a second frequency-domain resource, the first time-domain resource is the same as the second time-domain resource, and the first frequency-domain resource is different from the second frequency-domain resource.

For example, for descriptions of time-frequency resources respectively corresponding to a plurality of SSBs included in the first SS burst set in the second aspect, refer to the descriptions of the time-frequency resources respectively corresponding to the plurality of SSBs included in the first SS burst set in the first aspect. Details are not described herein again. In addition, for descriptions of a relationship between the first time-frequency resource corresponding to the first SSB and the second time-frequency resource corresponding to the second SSB in the second aspect, refer to those in the first aspect. Details are not described herein again.

For the second aspect, refer to the first aspect.

According to a third aspect, a communication apparatus is provided. The communication apparatus is configured to perform the method according to the first aspect. The communication apparatus includes a processor and a memory. The memory is configured to store a computer program. The processor is configured to invoke the computer program from the memory and run the computer program, to enable the communication apparatus to perform the method according to the first aspect.

The communication apparatus may be a network device, and the communication apparatus may include a transceiver unit and a processing unit. In this case, the transceiver unit may be a transceiver or an input/output interface, and the processing unit may be at least one processor. Optionally, the transceiver may be a transceiver circuit. Optionally, the input/output interface may be an input/output circuit.

The communication apparatus may be a chip, a chip system, or a circuit in a network device, and the communication apparatus may include a transceiver unit and a processing unit. In this case, the transceiver unit may be an input/output interface, an interface circuit, an output circuit, an input circuit, a pin, a related circuit, or the like on the chip, the chip system, or the circuit; and the processing unit may be at least one processor, processing circuit, logic circuit, or the like.

According to a fourth aspect, a communication apparatus is provided. The communication apparatus is configured to perform the method according to the second aspect. The communication apparatus includes a processor and a memory. The memory is configured to store a computer program. The processor is configured to invoke the computer program from the memory and run the computer program, to enable the communication apparatus to perform the method according to the second aspect.

The communication apparatus may be a terminal device, and the communication apparatus may include a transceiver unit and a processing unit. In this case, the transceiver unit may be a transceiver or an input/output interface, and the processing unit may be at least one processor. Optionally, the transceiver may be a transceiver circuit. Optionally, the input/output interface may be an input/output circuit.

The communication apparatus may be a chip, a chip system, or a circuit in a terminal device, and the communication apparatus may include a transceiver unit and a processing unit. In this case, the transceiver unit may be an input/output interface, an interface circuit, an output circuit, an input circuit, a pin, a related circuit, or the like on the chip, the chip system, or the circuit; and the processing unit may be at least one processor, processing circuit, logic circuit, or the like.

According to a fifth aspect, a non-transitory computer-readable storage medium is provided. The non-transitory computer-readable storage medium stores a computer program. When the computer program is run, the method according to the first aspect or the second aspect, is performed.

According to a sixth aspect, a computer program product including instructions is provided. When the computer program product is run, the method according to the first aspect or the second aspect is performed.

According to a seventh aspect, a chip is provided. The chip includes a processor and a communication interface. The processor reads instructions through the communication interface, to perform the method according to the first aspect or the second aspect.

Optionally, the chip further includes a memory. The memory stores a computer program or instructions. The processor is configured to execute the computer program or the instructions stored in the memory. When the computer program or the instructions are executed, the processor is configured to perform the method according to the first aspect or the second aspect.

According to an eighth aspect, a communication system is provided, including the communication apparatus according to the third aspect and the communication apparatus according to the fourth aspect.

According to a ninth aspect, a computer program is provided. When the computer program is run, the method according to the first aspect or the second aspect is performed.

### BRIEF DESCRIPTION OF DRAWINGS

FIG. 1 is a diagram of a communication system;

FIG. 2 is a diagram of a structure of an SSB;

FIG. 3 is a diagram of a beam sweeping-based SSB transmission process;

FIG. 4 is a diagram of candidate time-domain positions of SSBs in an SS burst set;

FIG. 5 is a schematic flowchart of a communication method according to an embodiment;

FIG. 6 is a diagram of resource allocation within an SS burst set according to an embodiment;

FIG. 7 is a block diagram of a communication apparatus according to an embodiment;

FIG. 8 is a diagram of another communication apparatus according to an embodiment; and

FIG. 9 is a diagram of a chip system according to an embodiment.

### DETAILED DESCRIPTION OF EMBODIMENTS

For ease of understanding of the embodiments, the following descriptions are provided.

First, “indicate” may include “directly indicate” and “indirectly indicate”. When a piece of indication information is described as indicating A, the indication information may directly indicate A or indirectly indicate A, but it does not necessarily mean that the indication information includes A.

Information indicated by the indication information is referred to as to-be-indicated information. There may be a plurality of embodiments for indicating the to-be-indicated information. The to-be-indicated information may be sent as a whole, or may be divided into a plurality of pieces of sub-information for separate sending. In addition, sending periodicities and/or sending occasions of these pieces of sub-information may be the same or different. A specific sending method is not limited. The sending periodicities and/or the sending occasions of these pieces of sub-information may be predefined, for example, predefined according to a protocol, or may be configured by a transmitter device by sending configuration information to a receiver device. The configuration information may include, but is not limited to, one or a combination of at least two of radio resource control (RRC) signaling, media access control (MAC) layer signaling, and physical layer signaling. The MAC layer signaling includes, for example, a MAC control element (CE), and the physical layer signaling includes, for example, downlink control information (DCI).

Second, “at least one” means one or more, and “a plurality of” means two or more. In addition, in the embodiments, “first”, “second”, and various numbers (for example, “#1” and “#2”) may be used for differentiation for ease of description, and are not intended to limit the embodiments. The sequence numbers in the following processes do not mean an execution sequence. The execution sequence of the processes should be determined based on functions and internal logic of the processes, and should not be construed as any limitation on the embodiments. Objects described in this way may be interchangeable in proper cases, so other embodiments may be described. In addition, in the embodiments, the terms such as “S510” and “S520” may be identifiers for ease of description, and do not limit a sequence of performing steps.

Third, the term such as “example” or “for example” represents providing an example, an illustration, or a description. Any embodiment described as an “example” or “for example” should not be explained as being more preferred or having more advantages than another embodiment. To be precise, use of the term such as “example” or “for example” is intended to present a related concept in a specific manner.

Fourth, “stored” in the embodiments may mean being stored in one or more memories. The one or more memories may be separately disposed, or may be integrated into an encoder or a decoder, a processor, or a communication apparatus. Alternatively, a part of the one or more memories may be separately disposed, and a part of the one or more memories may be integrated into a decoder, a processor, or a communication apparatus. A type of the memory may be a storage medium in any form. This is not limited.

Fifth, “protocols” in the embodiments may be standard protocols in the communication field, for example, may include an LTE protocol, an NR protocol, and a related protocol applied to a future communication system. This is not limited.

Sixth, in the embodiments, “in a case in which”, “when”, and “if” may be interchangeably used sometimes. When a difference between the terms is not emphasized, meanings to be expressed by the terms are consistent.

Seventh, in the embodiments, terms and English acronyms and abbreviations, such as radio resource control (RRC), are all examples provided for ease of description, and should not constitute any limitation and may not exclude a possibility of defining, in an existing or future protocol, another term that can implement a same or similar function.

Eighth, the term “and/or” may be an association relationship for describing associated objects, and may indicate that three relationships may exist. For example, A and/or B may indicate the following three cases: only A exists, both A and B exist, and only B exists. In addition, the character “/” may indicate an “or” relationship between associated objects.

The following describes the embodiments in detail with reference to the accompanying drawings.

The embodiments may be applied to various communication systems, for example, a 5th generation (5G) system or a new radio (NR) system, a long term evolution (LTE) system, an LTE frequency division duplex (FDD) system, and an LTE time division duplex (TDD) system. The embodiments may be further applied to a future communication system, for example, a sixth generation mobile communication system. The embodiments may be further applied to a device-to-device (D2D) communication system, a vehicle-to-everything (V2X) communication system, a machine-to-machine (M2M) communication system, a machine-type communication (MTC) system, an internet of things (IoT) communication system, or another communication system.

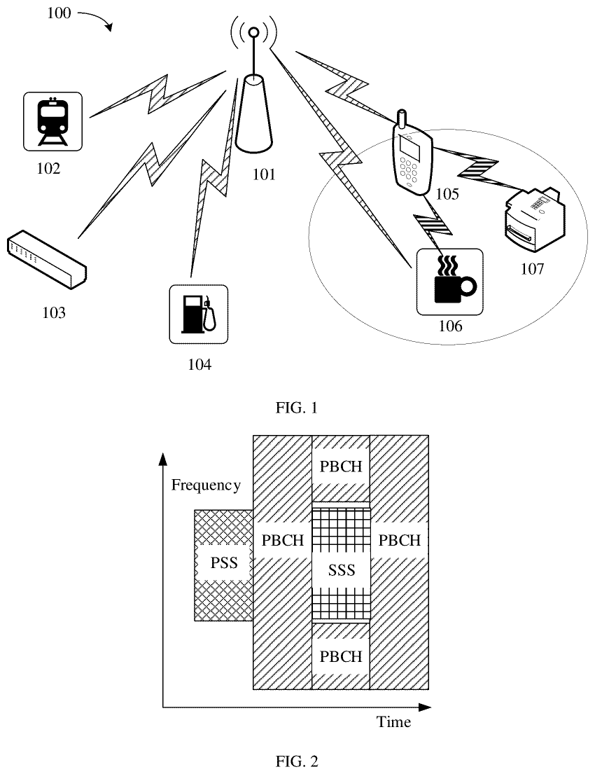

For the embodiments, for example, a communication system is first described with reference to FIG. 1. A terminal device (equipment) in the embodiments may be an access terminal, a subscriber unit, a subscriber station, a mobile station, a mobile console, a relay station, a remote station, a remote terminal, a mobile device, a user terminal, user equipment (UE), a terminal, a wireless communication device, a user agent, or a user apparatus. The terminal device may alternatively be a cellular phone, a cordless phone, a session initiation protocol (SIP) phone, a wireless local loop (WLL) station, a personal digital assistant (PDA), a handheld device having a wireless communication function, a compute device, another processing device connected to a wireless modem, a vehicle-mounted device, a wearable device, a terminal device in a 5G network, a terminal device in a future evolved public land mobile network PLMN), a terminal device in a future internet of vehicles, or the like. This is not limited in the embodiments.

For example, in the embodiments, the wearable device may also be referred to as a wearable intelligent device, and is a general term of wearable devices that are developed for daily wear by using a wearable technology, such as glasses, gloves, watches, clothing, and shoes. The wearable device is a portable device directly worn on a body or integrated into clothes or an accessory of a user. The wearable device may provide a powerful function through software support, data exchange, and cloud interaction. In a broad sense, the wearable intelligent device includes a full-featured device that may implement complete or partial functions without depending on a smartphone, for example, a smartwatch or smart glasses. In addition, the wearable intelligent device may alternatively be a portable device dedicated to only one type of function and needs to be used together with another device such as a smartphone, for example, various smart bands or smart jewelry for monitoring physical signs.

In addition, in the embodiments, the terminal device may alternatively be a terminal device in an IoT system. IoT is an important part in future development of information technology. The IoT may connect to a network by using a communication technology, to implement an intelligent network for human-machine interconnection and thing-thing interconnection. In the embodiments, the IoT technology can implement massive connections, deep coverage, and terminal power saving by using, for example, a narrowband (narrowband, NB) technology.

In addition, in the embodiments, the terminal device may alternatively include a sensor, and main functions include collecting data (some terminal devices), receiving control information and downlink data from a network device, sending an electromagnetic wave, and transmitting uplink data to the network device.

A network device in the embodiments may be any communication device having a wireless transceiver function configured to communicate with the terminal device. The device includes but is not limited to: an evolved NodeB (eNB), a radio network controller (RNC), a NodeB (NB), a home base station (HNB), a baseband unit (BBU), or an access point (AP), a wireless relay node, a wireless backhaul node, a transmission point (TP), a transmission and reception point (TRP), or the like in a wireless fidelity (Wi-Fi) system. Alternatively, the device may be a gNB or a transmission point (TRP or TP) in a 5G system such as an NR system, or may be one antenna panel or a group of antenna panels (including a plurality of antenna panels) of a base station in a 5G system, or may be a network node that forms a gNB or a transmission point, for example, a baseband unit (BBU) or a distributed unit (distributed unit, DU).

In different systems, a CU (or a CU-CP and a CU-UP), a DU, or an RU may have different names, but a person skilled in the art may understand meanings of the names. For example, the radio access network may be an open radio access network (O-RAN) architecture. In an ORAN system, the CU may also be referred to as an open CU (O-CU), the DU may also be referred to as an O-DU, the CU-CP may also be referred to as an O-CU-CP, the CU-UP may also be referred to as an O-CU-UP, and the RU may also be referred to as an O-RU. Any one of the CUS (or the CU-CP or the CU-UP), the DU, and the RU may be implemented by using a software module, a hardware module, or a combination of a software module and a hardware module.

The network device and the terminal device may be deployed on land, including indoors or outdoors, and in a hand-held manner or in a vehicle-mounted manner; may be deployed on water; or may be deployed on an airplane, a balloon, and a satellite in the air. Scenarios in which the network device and the terminal device are used are not limited in the embodiments.

In the embodiments, the terminal device or the network device includes a hardware layer, an operating system layer running on the hardware layer, and a disclosure layer running on the operating system layer. The hardware layer includes hardware such as a central processing unit (CPU), a memory management unit (MMU), and a memory (also referred to as a main memory). The operating system may be any one or more types of computer operating systems that implement service processing through a process, for example, a Linux® operating system, a Unix® operating system, an Android® operating system, an iOS® operating system, or a Windows® operating system. The disclosure layer includes disclosures such as a browser, an address book, word processing software, and instant messaging software.

In addition, aspects or features may be implemented as a method, an apparatus, or a product that uses standard programming and/or engineering technologies. The term “product” may cover a computer program that can be accessed from any computer-readable component, carrier or medium. For example, the non-transitory computer-readable medium includes but is not limited to a magnetic storage component (for example, a hard disk, a floppy disk, or a magnetic tape), an optical disc (for example, a compact disc (CD) or a digital versatile disc (DVD)), a smart card, and a flash memory component (for example, an erasable programmable read-only memory (EPROM), a card, a stick, or a key drive). In addition, various storage media described herein may represent one or more devices and/or other non-transitory machine-readable media that are configured to store information.

For ease of understanding of the embodiments, the communication system to which the embodiments are applicable is first described in detail by using the communication system shown in FIG. 1 as an example. As shown in FIG. 1, the communication system 100 may include at least one network device 101 and at least one of terminal devices 102 to 107. The terminal devices 102 to 107 may be mobile or fixed. The network device 101 may communicate with one or more of the terminal devices 102 to 107 through a radio link. Each network device may provide communication coverage for a particular geographical area, and may communicate with a terminal device located in the coverage area.

Optionally, the terminal devices may directly communicate with each other. For example, direct communication between the terminal devices may be implemented by using a device-to-device (D2D) technology. As shown in FIG. 1, direct communication may be implemented between the terminal devices 105 and 106 and between the terminal devices 105 and 107 by using the D2D technology. The terminal device 106 and the terminal device 107 may separately or simultaneously communicate with the terminal device 105.

Alternatively, the terminal devices 105 to 107 may separately communicate with the network device 101. For example, the terminal devices 105 to 107 may directly communicate with the network device 101. For example, the terminal devices 105 and 106 in the figure may directly communicate with the network device 101. Alternatively, the terminal devices 105 to 107 may indirectly communicate with the network device 101. For example, the terminal device 107 in FIG. 1 communicates with the network device 101 via the terminal device 105.

A plurality of antennas may be configured for each communication device. For each communication device in the communication system 100, the plurality of antennas configured may include at least one transmit antenna configured to send a signal and at least one receive antenna configured to receive a signal. Therefore, the communication devices in the communication system 100 may communicate with each other by using a multi-antenna technology.

An interface between the network device and the terminal device may be a Uu interface (or referred to as an air interface). In future communication, names of these interfaces may remain unchanged, or may be replaced with other names. This is not limited. For example, communication between the network device and the terminal device complies with a specific protocol layer structure. Network layering means that operations of network nodes (for example, the network device and the terminal device) such as sending, forwarding, encapsulating, or decapsulating data, and adding or extracting control information are respectively performed by different hardware and software modules. In this way, a complex problem of communication and network interconnection can be simplified.

FIG. 1 may be a simplified diagram of an example for ease of understanding. The communication system 100 may further include another network device or may further include another terminal device (not shown in FIG. 1). For example, the communication system 100 may further include a core network device. An access network device provides a radio access connection for the terminal device, and may send data to the terminal device or receive data sent by the terminal device. In addition, the access network device is also connected to the core network device, and may forward, to a core network, the data received from the terminal device, or receive, from a core network, data that needs to be sent to the terminal device.

For example, the communication system 100 may further include a disclosure function (AF) network element. The AF network element is a control plane network function provided by an operator network, and is configured to provide disclosure layer information. The communication system 100 may further include a session management function (SMF) network element. The SMF network element is a control plane network function provided by the operator network. In this embodiment, when the communication system 100 includes the AF network element and the SMF network element, the AF network element may send service-related information to the network device via the SMF network element.

For ease of understanding of the embodiments, some basic concepts in this disclosure are briefly described.

1. Synchronization signal/physical broadcast channel block (SSB): In an NR system, during access to a base station, a terminal may perform time and frequency synchronization with the base station and obtain broadcast information through a synchronization signal/physical broadcast channel block.

The SSB may include synchronization signals (synchronization signals) and a physical broadcast channel (PBCH). The synchronization signals may include a primary synchronization signal (PSS) and a secondary synchronization signal (SSS). The terminal device may complete time and frequency synchronization with the base station through the PSS and the SSS, and obtain a physical-layer cell identity PCI). The PBCH may carry the broadcast information, including a master information block (MIB) from a higher layer and timing-related information from a physical layer. The SSB may further be used for channel quality measurement, radio resource management (RRM) measurement, and radio link monitoring (RLM).

For example, physical time-frequency resources within an SSB is shown in the following Table 1:

TABLE 1

| | Orthogonal frequency | |
|---|---|---|
| | division multiplexing (OFDM) | |
| | symbol number relative to the | Subcarrier number relative to the |
| Channel or signal | start of an SS/PBCH block | start of an SS/PBCH block |
| PSS | 0 | 56, 57, . . . , 182 |
| SSS | 2 | 56, 57, . . . , 182 |
| Set to 0 (set to 0) | 0 | 0, 1, . . . , 55, 183, 184, . . . , 239 |
| | 2 | 48, 49, . . . , 55, 183, 184, . . . , 191 |
| PBCH | 1, 3 | 0, 1, . . . , 239 |
| | 2 | 0, 1, . . . , 47, 192, 193, . . . , 239 |
| Demodulation reference | 1, 3 | 0 + v, 4 + v, 8 + v, . . . , 236 + v |
| signal (DM-RS) for | 2 | 0 + v, 4 + v, 8 + v, . . . , 44 + v, |
| PBCH | | 192 + v, 196 + v, . . . , 236 + v |

In addition, for ease of understanding, a structure of an SSB is briefly described with reference to FIG. 2. As shown in FIG. 2, an SSB includes a PSS, an SSS, and a PBCH.

2. Time-domain position of an SSB: To improve coverage performance of the SSB, NR introduces a beam sweeping mechanism for SSB transmission. The base station repeatedly transmits the SSB in different directions on different beams. In a beam direction, a received power of the SSB at the terminal can be higher due to a higher concentration of energy, thereby improving the coverage performance of the SSB. For the foregoing beam-based SSB transmission process, time division multiplexing is performed between different SSB beams. In other words, the base station sends the SSB on different beams at different times. An SSB set in one beam sweep is referred to as a synchronization signal (SS) burst set.

The NR protocol may specify that duration of an SS burst set is 5 ms, so that transmission of all SSBs may be completed within 5 ms. The 5 ms is a first half-frame or a second half-frame of a 10-ms system frame. In addition, the SS burst set is periodically transmitted in time domain. Periodic transmission of the SS burst set may also be considered as periodic transmission of each SSB in the SS burst set. Therefore, a periodicity of the SS burst set may also be a periodicity of the SSB. In an initial access phase, the terminal assumes by default that the periodicity of the SS burst set is 20 ms.

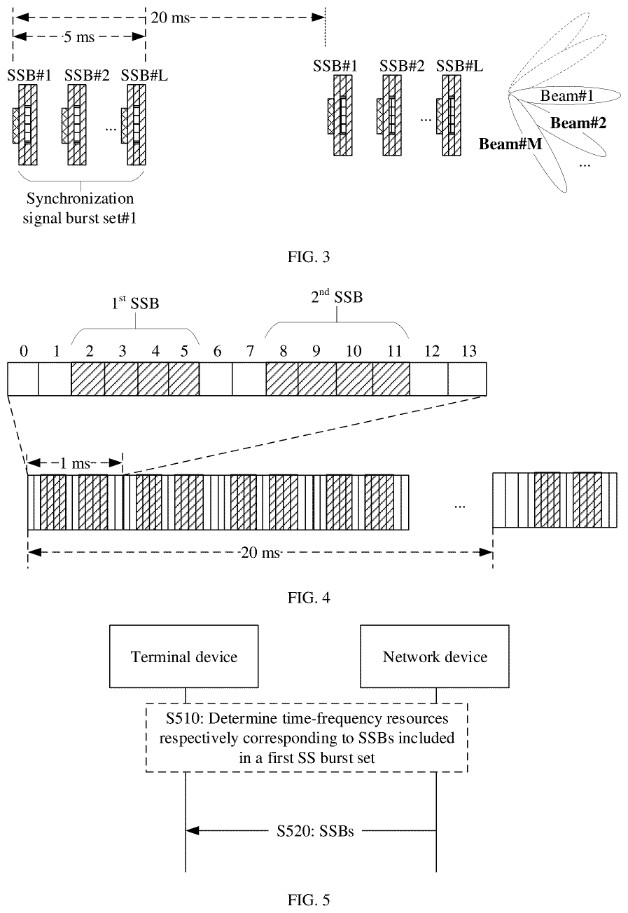

For ease of understanding, a beam sweeping-based SSB transmission process is briefly described with reference to FIG. 3. An SS burst set (for example, a synchronization signal burst set #1 shown in FIG. 3) includes L SSBs (for example, an SSB #1, an SSB #2, . . . , and an SSB #L shown in FIG. 3), transmission of the L SSBs is completed within 5 ms, and a periodicity of the SSBs is 20 ms (for example, a time interval between a 1^{st} SSB #1 and a 2^{nd} SSB #1 shown in FIG. 3 is 20 ms). The L SSBs included in the SS burst set may be sent on M beams (for example, a beam #1, a beam #2, . . . , and a beam #M shown in FIG. 3), where M and L are positive integers greater than 1.

3. Maximum quantity of SSBs: A maximum quantity of SSBs included in a synchronization signal burst set varies across different frequency bands. For frequency bands below 3 GHz, an SS burst set includes a maximum of four SSBs, and SSB beam sweeping is performed using a maximum of four beams. For frequency bands between 3 GHz and 6 GHZ, an SS burst set includes a maximum of eight SSBs, and SSB beam sweeping is performed using a maximum of eight beams. For frequency bands above 6 GHz, for example, FR2, an SS burst set includes a maximum of 64 SSBs, and SSB beam sweeping is performed using a maximum of 64 beams.

In addition, time-domain positions of a plurality of SSBs in an SS burst set within 5 ms are predefined in a protocol, and are related to a subcarrier spacing (SCS). For ease of understanding, candidate time-domain positions of SSBs in an SS burst set are briefly described with reference to FIG. 4. For a frequency band between 3 GHz and 6 GHZ, when an SCS is 15 kHz, positions (indexes of starting symbols, such as 1^{st} symbols) of eight SSBs are {2, 8}+14·n, where n=0, 1.

The foregoing quantity of SSBs may be a maximum quantity of SSBs in an SS burst set. In practice, the base station may send a part or all of SSBs as required, and the sent SSBs are not required to be at consecutive candidate SSB positions. For example, for eight candidate SSB positions in FIG. 4, the base station may select any quantity of the eight candidate SSB positions for SSB transmission.

4. Frequency-domain position of an SSB: As defined in NR, all SSBs are located on a synchronization raster. The synchronization raster defines candidate frequency positions of the SSBs. In an initial access phase, the terminal device may detect an SSB on the synchronization raster to perform cell search, to acquire time and frequency synchronization with a cell and detect a physical-layer cell identifier PCI of the cell.

For all frequencies, NR defines a global synchronization raster. A frequency position of an SSB is defined as SS_{REF} with a corresponding number, global synchronization channel number (GSCN). Parameters defining SS_{REF} and GSCN for all the frequency ranges are shown in the following Table 2 or Table 3.

TABLE 2
GSCN parameters for a global frequency raster

| Frequency | Synchronization signal (SS) block | | Range of |
|---|---|---|---|
| range | frequency position (SS_{REF}) | GSCN | GSCN |
| 0-3000 | N*1200 kHz + M*50 kHz, | 3N + (M − 3)/2 | 2-7498 |
| MHz | N = 1:2499, Mϵ{1, 3, 5} (Note 1) | | |
| 3000-24250 | 3000 MHz + N*1.44 MHz, | 7499 + N | 7499-22255 |
| MHz | N = 0:14756 | | |

TABLE 3
GSCN parameters for a global frequency raster

| Frequency | | | Range of |
|---|---|---|---|
| range | SS block frequency position SS_{REF} | GSCN | GSCN |
| 24250-100000 | 24250.08 MHz + N*17.28 MHz, | 22256 + N | 22256-26639 |
| MHz | N = 0:4383 | | |

A mapping between a synchronization raster and a corresponding resource element of an SSB is as follows: An RE whose index is 120 of the SSB is located on the synchronization raster.

The requirement for the SSB to be located on the synchronization raster may apply to a cell-defining SSB (CD-SSB). Correspondingly, there is also a non-cell-defining SSB (NCD-SSB). The CD-SSB is an SSB that can be used for cell search and access. The CD-SSB may be associated with an SIB1. After receiving the SSB, the terminal may proceed to receive the associated SIB1, to perform cell camping, cell access, and the like. Therefore, the CD-SSB is required to be located on the synchronization raster. The NCD-SSB may be used only for measurement rather than for cell search, cell access, or the like, and is not associated with an SIB1. Therefore, the NCD-SSB is not required to be located on the synchronization raster. The NCD-SSB may or may not be located on the synchronization raster, which may depend on the base station.

5. Content of a PBCH: Higher-layer parameters of a PBCH in 5G are as follows:

| | |
|---|---|
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |
| } | |

In addition, there are 9 additional bits in a payload of the PBCH, including 1 choice bit and 8 physical-layer bits. For a low-frequency system, first 4 bits are last 4 bits of a system frame number, a 5^{th} bit is a half-frame indicator, a 6^{th} bit is a last bit of Kssb, and 7^{th} and 8th bits are reserved.

6. Expanding a quantity of SSBs: Higher frequencies may be used in subsequent communication protocols, and therefore enhanced coverage performance is required. For example, a 5G system and a future communication system may be deployed on a same frequency. More SSBs may be used for coverage in the future communication system, and SSB signals may also be deployed in the 5G system. Therefore, there may be a need to deploy two sets of SSB signals within a same frequency range.

The foregoing briefly describes, with reference to FIG. 1, the scenario to which a communication method provided in the embodiments is applicable, describes the basic concepts that may be involved in non-transitory embodiments, and describes the SSB transmission embodiments, where transmission of a plurality of SSBs in an SS burst set is performed in a time division multiplexing manner.

The SSB transmission manner may have the following problems:
(1) At sub-6 GHz frequencies, an SS burst set includes a maximum of eight SSBs. However, at higher frequencies such as 6 GHz and the like, more broadcast beams are used for cell coverage, where each broadcast beam requires one SSB for access by UE. Therefore, eight SSBs are insufficient for broadcast coverage of a cell in mid-frequency bands.
(2) SSB signals are deployed independently for the 5G system and the future communication system respectively, which increases common overheads of a cell and is not conducive to improving spectrum utilization.

To resolve the foregoing problem of an insufficient quantity of SSBs, and to share SSB signals between the 5G system and the future communication system for reduced system overheads and improved spectrum utilization, the embodiments may provide a communication method. The communication method expands an existing quantity of SSBs in an SS burst set by performing frequency division multiplexing between different SSB beams in a same cell, transmitting different SSB beams on different frequency resources.

The communication method provided in the embodiments may be applied to a system that performs communication using a multi-antenna technology, for example, the communication system 100 shown in FIG. 1. The communication system may include at least one network device and at least one terminal device.

A structure of an entity for performing the method provided in the embodiments is not particularly limited in the embodiments described below, provided that the entity can run a program that records code of the method provided in the embodiments to perform communication according to the method provided in the embodiments. For example, the entity for performing the method provided in the embodiments may be a terminal device, or may be a functional module in the terminal device and that can invoke and execute a program.

FIG. 5 is a schematic flowchart of a communication method according to an embodiment. The communication method includes the following steps.

S510: A network device and a terminal device determine time-frequency resources respectively corresponding to a plurality of SSBs included in a first SS burst set.

Before transmission of the plurality of SSBs included in the first SS burst set, the network device and the terminal device may determine time-frequency resources respectively corresponding to the plurality of SSBs included in the first SS burst set, or the network device and the terminal device may learn of time-frequency resources to which the plurality of SSBs are respectively mapped.

The time-frequency resources respectively corresponding to the plurality of SSBs included in the first SS burst set may be predefined in a protocol or configured by a management device. For example, corresponding maximum quantities of SSBs that can be included in an SS burst set in different frequency bands are defined in the protocol, where time-domain positions of a plurality of SSBs in an SS burst set within 5 ms are predefined in the protocol, and are related to an SCS.

The first SS burst set may be any SS burst set, the first SS burst set includes the plurality of SSBs, and each of the plurality of SSBs corresponds to one time-frequency resource. For example, for a frequency band between 3 GHz and 6 GHZ, the first SS burst set includes 16 SSBs (for example, an SSB #0, an SSB #1, . . . , an SSB #14, and an SSB #15). The 16 SSBs are in a one-to-one correspondence with 16 time-frequency resources (for example, the SSB #0 corresponds to a time-frequency resource #0, the SSB #1 corresponds to a time-frequency resource #1, . . . , the SSB #14 corresponds to a time-frequency resource #14, and the SSB #15 corresponds to a time-frequency resource #15). For example, for frequency bands below 3 GHZ, the first SS burst set includes 8 SSBs (for example, an SSB #0, an SSB #2, . . . , an SSB #6, and an SSB #7). The 8 SSBs are in a one-to-one correspondence with 8 time-frequency resources (for example, the SSB #0 corresponds to a time-frequency resource #0, the SSB #0 corresponds to a time-frequency resource #1, . . . , the SSB #6 corresponds to a time-frequency resource #6, and the SSB #7 corresponds to a time-frequency resource #7).

In this embodiment, an SSB corresponding to a time-frequency resource may mean as that the SSB is carried on the time-frequency resource, or that the SSB is transmitted on the time-frequency resource.

The time-frequency resource in this embodiment may include a time-domain resource and a frequency-domain resource. The time-domain resource may be a time unit that can represent a time-domain resource, for example, a slot, a symbol, or a frame. The frequency-domain resource may be a frequency-domain unit that can represent a frequency-domain resource, for example, a subcarrier.

In this embodiment, the first SS burst set includes a first SSB and a second SSB. The first SSB corresponds to a first time-frequency resource (or the first SSB is in a correspondence with a first time-frequency resource, or the first SSB is mapped to a first time-frequency resource). The second SSB corresponds to a second time-frequency resource (or the second SSB is in a correspondence with a second time-frequency resource, or the second SSB is mapped to a second time-frequency resource). The first time-frequency resource includes a first time-domain resource and a first frequency-domain resource. The second time-frequency resource includes a second time-domain resource and a second frequency-domain resource. The first time-domain resource is the same as the second time-domain resource. The first frequency-domain resource is different from the second frequency-domain resource. a plurality of SSBs may be sent on a same time-domain resource in a frequency division manner. Therefore, in this embodiment, different SSBs may be transmitted on different frequency-domain resources. This can expand a quantity of SSBs in an SS burst set beyond that of a case in which SSB transmission is performed only in a time division multiplexing manner.

For example, for frequency bands between 3 GHZ and 6 GHz, when SSB transmission is performed in a time division multiplexing manner, an SS burst set includes a maximum of eight SSBs. If the time-frequency resource allocation scheme for SSBs in this embodiment is used and a plurality of SSBs may be sent on a same time-domain resource in a frequency division manner, for the frequency bands between 3 GHz and 6 GHz, an SS burst set includes a maximum of 8*n SSBs, where n is an integer greater than 1. For example, for a frequency band between 3 GHz and 6 GHZ, the first SS burst set includes 16 SSBs, and positions (indexes of starting symbols, such as 1^{st} symbols) of the 16 SSBs are {2, 8}+14·n, where n=0, 1, and two SSBs are on a same symbol.

Optionally, that the time-domain resource of the first time-frequency resource corresponding to the first SSB is the same as the time-domain resource of the second time-frequency resource corresponding to the second SSB may be: The time-domain resource of the first time-frequency resource and the time-domain resource of the second time-frequency resource are a first OFDM symbol in a first slot. In other words, the two SSBs may be on a same OFDM symbol. One or more SSBs being on the first OFDM symbol may mean that the time-domain resource of the first time-frequency resource and the time-domain resource of the second time-frequency resource occupy one or more OFDM symbols, and the one or more OFDM symbols are collectively referred to as the first OFDM symbol.

The first SSB and the second SSB may be examples and do not constitute any limitation on the embodiments. Two or more SSBs in the first SS burst set may be on a same OFDM symbol. For example, a time-domain resource of the time-frequency resource #1 corresponding to the SSB #1 other than the first SSB and the second SSB in the first SS burst set may also be the first OFDM symbol.

Optionally, DMRS sequences corresponding to the two or more SSBs in the first SS burst set that are on the same OFDM symbol are the same. For example, the first SSB includes a first physical broadcast channel PBCH, the second SSB includes a second PBCH, the first PBCH corresponds to a first demodulation reference signal DMRS sequence, the second PBCH corresponds to a second DMRS sequence, and the first DMRS sequence is the same as the second DMRS sequence.

For example, to distinguish between the two or more SSBs on the same OFDM symbol, one field in a PBCH of each of the two or more SSBs indicates the corresponding SSB. For example, the first SSB includes the first physical broadcast channel PBCH, the second SSB includes the second PBCH, the first PBCH includes first indication information, the second PBCH includes second indication information, the first indication information indicates the first SSB, and the second indication information indicates the second SSB.

Optionally, the first indication information includes a first index, the first index indicates the first SSB, the second indication information includes a second index, and the second index indicates the second SSB.

By way of example, the first indication information is indicated by a first bit in the first PBCH, the second indication information is indicated by a second bit in the second PBCH, a value of the first bit is different from a value of the second bit, the first bit includes at least one bit, and the second bit includes at least one bit. For example, the first bit includes X bits, and the second bit includes X bits. For another example, the first bit is 1 bit, and the second bit is 1 bit. The value of the first bit is 0, and the value of the second bit is 1; or the value of the first bit is 1, and the value of the second bit is 0; or the value of the first bit is A, and the value of the second bit is 1-A.

Optionally, the first bit is in a first field in the first PBCH, the second bit is in a second field in the second PBCH, the first field includes a choice field or a reserved field of the first PBCH, and the second field includes a choice field or a reserved field of the second PBCH. The reserved field includes spare or reserved.

Further, the first SS burst set further includes a third SSB and a fourth SSB. The third SSB corresponds to a third time-frequency resource. The fourth SSB corresponds to a fourth time-frequency resource. The third time-frequency resource includes a third time-domain resource and a third frequency-domain resource. The fourth time-frequency resource includes a fourth time-domain resource and a fourth frequency-domain resource. The third time-domain resource is the same as the fourth time-domain resource. The third frequency-domain resource is different from the fourth frequency-domain resource. The third time-domain resource is a second OFDM symbol, and the second orthogonal frequency division multiplexing symbol is in the first slot.

In this embodiment, the first SS burst set may further include an SSB other than the first SSB, the second SSB, the third SSB, or the fourth SSB. For example, the first SS burst set includes 16 SSBs, every four SSBs of the 16 SSBs are in one slot, and SSBs in different slots are different.

For ease of understanding, the following describes, with reference to a specific example, that the SSBs included in the first SS burst set broadcast by the network device are carried on different time-frequency resources.

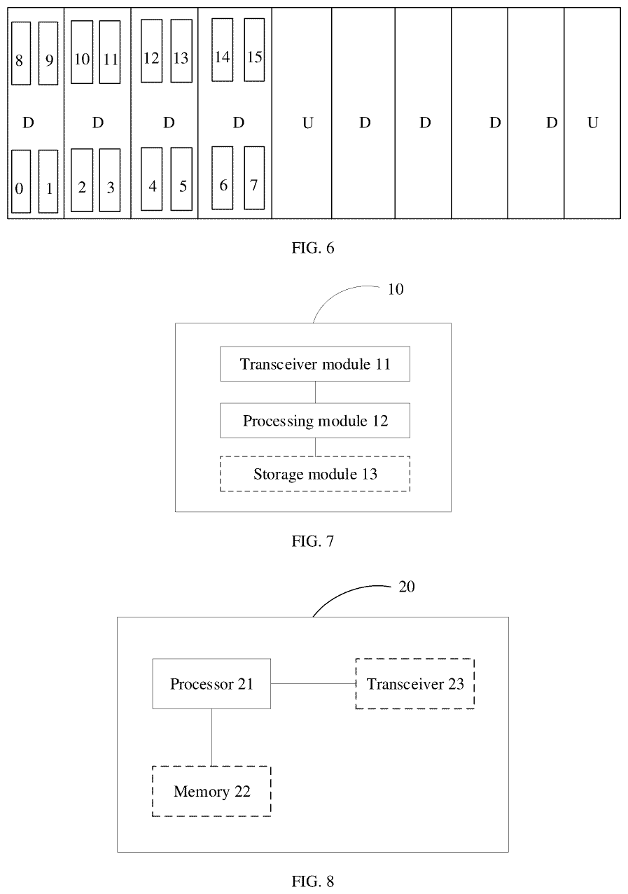

As shown in FIG. 6, resource allocation, in a TDD period, for the first SS burst set broadcast by the network device is as follows: In time domain, the 16 SSBs included in the first SS burst set are sent in four downlink slots, and there are four SSBs in each downlink slot. The 16 SSB bursts are numbered from 0 to 15. The SSBs numbered 0, 1, 8, and 9 are in a 1^{st} downlink slot, the SSBs numbered 2, 3, 10, and 11 are in a 2^{nd} downlink slot, the SSBs numbered 4, 5, 12, and 13 are in a 3^{rd} downlink slot, and the SSBs numbered 6, 7, 14, and 15 are in a 4th downlink slot.

The SSBs numbered 0 and 8 in the 1^{st} downlink slot are at a same time-domain position. The SSBs numbered 1 and 9 in the 1^{st} downlink slot are at a same time-domain position. The SSBs numbered 2 and 10 in the 2^{nd} downlink slot are at a same time-domain position. The SSBs numbered 3 and 11 in the 2^{nd} downlink slot are at a same time-domain position. The SSBs numbered 4 and 12 in the 3^{rd} downlink slot are at a same time-domain position. The SSBs numbered 5 and 13 in the 3^{rd} downlink slot are at a same time-domain position. The SSBs numbered 6 and 14 in the 4^{th} downlink slot are at a same time-domain position. The SSBs numbered 7 and 15 in the 4^{th} downlink slot are at a same time-domain position. Two SSBs with a number difference of 8 in a same downlink slot may be on a same OFDM symbol.

The resource configuration shown in FIG. 6 may be an example and does not constitute any limitation on the embodiments. For example, SSBs numbered n, n+1, n+8, and n+9 are in a same slot, where n is an integer. For another example, two SSBs with a number difference of 16 may be on a same OFDM symbol in a same slot. For another example, a slot that the SSB is in may be another slot (for example, a flexible slot or an uplink slot) other than the downlink slot shown in FIG. 6.

S520: The network device sends the plurality of SSBs to the terminal device, and correspondingly, the terminal device receives the plurality of SSBs from the network device.

The network device may send the plurality of SSBs to the terminal device on the time-frequency resources respectively corresponding to the plurality of SSBs, and correspondingly, the terminal device may receive the plurality of SSBs from the network device on the time-frequency resources respectively corresponding to the plurality of SSBs. In other words, after determining, in the embodiment shown in step S510, the time-frequency resources respectively corresponding to the plurality of SSBs in the first SS burst set, the network device and the terminal device may perform SSB transmission on the determined time-frequency resources.

For example, the network device sends the first SSB on the first time-frequency resource, and the terminal device receives the first SSB on the first time-frequency resource. For another example, the network device sends the second SSB on the second time-frequency resource, and the terminal device receives the second SSB on the second time-frequency resource. For another example, the network device sends the third SSB on the third time-frequency resource, and the terminal device receives the third SSB on the third time-frequency resource. For another example, the network device sends the fourth SSB on the fourth time-frequency resource, and the terminal device receives the fourth SSB on the fourth time-frequency resource.

For example, the network device may send the plurality of SSBs in the first SS burst set in different directions on a plurality of beams. For an actual process and manner in which the network device sends the SSBs, no limitation is imposed in this embodiment, and reference may be made to descriptions, in a current related technology, of the network device sending an SSB after determining a time-frequency resource corresponding to the SSB. Details are not described herein.

In the communication method shown in FIG. 5, time-frequency resource positions and a quantity of SSBs in an expanded SS burst set are defined, thereby providing more SSBs and increasing a quantity of SSBs in a cell. As a result, synchronization resources can be provided for more broadcast beams, thereby achieving an enhanced cell coverage capability. In addition, SSBs in a same SS burst set that are at a same time-domain position are distinguished by values of fields in PBCHs, so that a terminal device can identify the SSBs. For example, when a 5G terminal device and a terminal device in a future communication system share a spectrum, the 5G terminal device and the terminal device in the future communication system can identify SSBs based on values of fields in PBCHs and determine corresponding deployed SSBs (for example, the 5G terminal device corresponds to an SSB in which a value of a field in a PBCH is A, and the terminal device in the future communication system corresponds to an SSB in which a value of a field in a PBCH is 1-A), thereby eliminating a need to deploy respective SSB signals. This reduces common overheads of a cell, and improves spectrum utilization.

Sequence numbers of the foregoing processes may not mean an execution sequence. The execution sequence of the processes should be determined based on functions and internal logic of the processes, and should not be construed as any limitation on the embodiments.

In the embodiments, unless otherwise stated or there is a logic conflict, terms and/or descriptions in the different embodiments may be consistent and may be mutually referenced, and the different embodiments may be combined based on an internal logical relationship thereof, to form a new embodiment.

In some of the foregoing embodiments, devices in a conventional network architecture (for example, a network device and a terminal device) may be used as an example for description. Forms of the devices may not be limited in the embodiments. For example, all devices that can implement a same function in the future may be applicable to the embodiments.

In the foregoing method embodiments, the method and operations implemented by a device (for example, the network device or the terminal device) may alternatively be implemented by a component (for example, a chip or a circuit) of the device.

The foregoing describes in detail, with reference to FIG. 5, the communication method provided in the embodiments. The foregoing communication method may be described from a perspective of interaction between the terminal device and the network device. To implement the foregoing functions, the terminal device and the network device may include corresponding hardware structures and/or software modules for performing the functions.

A person skilled in the art should be aware that, the units and algorithm steps in the examples described with reference to the embodiments may use hardware or a combination of hardware and computer software. Whether a function is performed by hardware or hardware driven by computer software depends on the embodiments. The person skilled in the art may use different methods to implement the described functions for each embodiment.

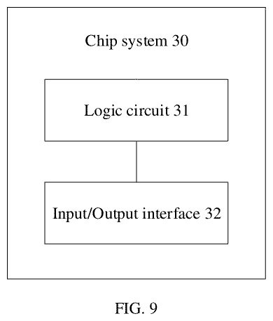

The following describes in detail a communication apparatus provided with reference to FIG. 7 and FIG. 9. Descriptions of apparatus embodiments correspond to the descriptions of the method embodiments. Therefore, for content not described in detail, refer to the foregoing method embodiments. For brevity, some content is not described again.

In the embodiments, functional modules of a transmitter device or a receiver device may be obtained through division based on the foregoing method examples. For example, each functional module may be obtained through division based on each function, or two or more functions may be integrated into one processing module. The integrated module may be implemented in a form of hardware, or may be implemented in a form of software functional module. In the embodiments, division into the modules is an example, and may be logical function division. Another division embodiment may be used. The following provides descriptions by using an example in which each functional module is obtained through division based on each function.

FIG. 7 is a block diagram of a communication apparatus 10 according to an embodiment. The apparatus 10 includes a transceiver module 11 and a processing module 12. The transceiver module 11 may implement a corresponding communication function, and the processing module 12 is configured to perform data processing; or the transceiver module 11 is configured to perform receiving-related and sending-related operations, and the processing module 12 is configured to perform an operation other than receiving and sending. The transceiver module 11 may also be referred to as a communication interface or a communication unit.

Optionally, the apparatus 10 may further include a storage module 13. The storage module 13 may be configured to store instructions and/or data. The processing module 12 may read the instructions and/or the data in the storage module, to enable the apparatus to implement actions of a device in the foregoing method embodiments.

The apparatus 10 may correspond to the terminal device in the foregoing method embodiments, or a component (for example, a chip) of the terminal device.

The apparatus 10 may implement corresponding steps or procedures performed by the terminal device in the foregoing method embodiments. The transceiver module 11 may be configured to perform receiving-related and sending-related operations of the terminal device in the foregoing method embodiments, and the processing module 12 may be configured to perform a processing-related operation of the terminal device in the foregoing method embodiments.

The transceiver module 11 is configured to receive a first synchronization signal/physical broadcast channel block SSB on a first time-frequency resource; and the transceiver module 11 is configured to receive a second SSB on a second time-frequency resource, where the first SSB and the second SSB belong to a first synchronization signal SS burst set, the first time-frequency resource includes a first time-domain resource and a first frequency-domain resource, the second time-frequency resource includes a second time-domain resource and a second frequency-domain resource, the first time-domain resource is the same as the second time-domain resource, and the first frequency-domain resource is different from the second frequency-domain resource.

When the apparatus 10 is configured to perform the method in FIG. 5, the transceiver module 11 may be configured to perform steps of receiving and sending information in the method, for example, step S520, and the processing module 12 may be configured to perform a processing step in the method, for example, step S510.

A process in which the units perform the foregoing corresponding steps is described in detail in the foregoing method embodiments. For brevity, details are not described herein again.

The apparatus 10 may correspond to the network device in the foregoing method embodiments, or a component (for example, a chip) of the network device.

The apparatus 10 may implement corresponding steps or procedures performed by the network device in the foregoing method embodiments. The transceiver module 11 may be configured to perform receiving-related and sending-related operations of the network device in the foregoing method embodiments, and the processing module 12 may be configured to perform a processing-related operation of the network device in the foregoing method embodiments.

The transceiver module 11 is configured to send a first synchronization signal/physical broadcast channel block SSB on a first time-frequency resource; and the transceiver module 11 is configured to send a second SSB on a second time-frequency resource, where the first SSB and the second SSB belong to a first synchronization signal SS burst set, the first time-frequency resource includes a first time-domain resource and a first frequency-domain resource, the second time-frequency resource includes a second time-domain resource and a second frequency-domain resource, the first time-domain resource is the same as the second time-domain resource, and the first frequency-domain resource is different from the second frequency-domain resource.

When the apparatus 10 is configured to perform the method in FIG. 5, the transceiver module 11 may be configured to perform steps of receiving and sending information in the method, for example, step S520, and the processing module 12 may be configured to perform a processing step in the method, for example, step S510.

A process in which the units perform the foregoing corresponding steps is described in detail in the foregoing method embodiments. For brevity, details are not described herein again.

Apparatus 10 herein is embodied in a form of functional module. The term “module” herein may be an application-specific integrated circuit (ASIC), an electronic circuit, a processor (for example, a shared processor, a dedicated processor, or a group processor) configured to execute one or more software or firmware programs, a memory, a combinational logic circuit, and/or another suitable component that supports the described function. In an optional example, a person skilled in the art may understand that the apparatus 10 may be a mobility management network element in the foregoing embodiments, and may be configured to perform procedures and/or steps corresponding to the mobility management network element in the foregoing method embodiments. Alternatively, the apparatus 10 may be the terminal device in the foregoing embodiments, and may be configured to perform procedures and/or steps corresponding to the terminal device in the foregoing method embodiments. To avoid repetition, details are not described herein again.

The apparatus 10 may correspond to steps performed by a device (for example, the terminal device or the network device) in the foregoing method. The function may be implemented by hardware, or may be implemented by hardware executing corresponding software. The hardware or the software includes one or more modules corresponding to the foregoing functions. For example, the transceiver module may be replaced with a transceiver (for example, a sending unit in the transceiver module may be replaced with a transmitter, and a receiving unit in the transceiver module may be replaced with a receiver), and another unit such as the processing module may be replaced with a processor, to respectively perform receiving and sending operations and a related processing operation in the method embodiments.

In addition, the transceiver module 11 may alternatively be a transceiver circuit (for example, may include a receiving circuit and a sending circuit), and the processing module may be a processing circuit.

FIG. 8 is a diagram of another communication apparatus 20 according to an embodiment. The apparatus 20 includes a processor 21. The processor 21 is configured to execute a computer program or instructions stored in a memory 22, or read data/signaling stored in the memory 22, to perform the method in the foregoing method embodiments. Optionally, there are one or more processors 21.

Optionally, as shown in FIG. 8, the apparatus 20 further includes the memory 22, and the memory 22 is configured to store the computer program or the instructions, and/or the data. The memory 22 and the processor 21 may be integrated together, or may be disposed separately. Optionally, there are one or more memories 22.

Optionally, as shown in FIG. 8, the apparatus 20 further includes a transceiver 23, and the transceiver 23 is configured to receive a signal and/or send a signal. For example, the processor 21 is configured to control the transceiver 23 to receive a signal and/or send a signal.

The apparatus 20 is configured to implement operations performed by the terminal device in the foregoing method embodiments.

The processor mentioned in the embodiments may be a central processing unit (CPU), or may be another general-purpose processor, a digital signal processor (DSP), an application-specific integrated circuit (ASIC), a field programmable gate array (FPGA) or another programmable logic device, a discrete gate or a transistor logic device, a discrete hardware component, or the like. The general-purpose processor may be a microprocessor, or the processor may be any conventional processor or the like.

The memory mentioned in the embodiments may be a volatile memory and/or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM).

For example, the RAM may be used as an external cache. By way of example and not limitation, the RAM includes a plurality of forms, such as a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

When the processor is a general-purpose processor, a DSP, an ASIC, an FPGA or another programmable logic device, a discrete gate or a transistor logic device, or a discrete hardware component, the memory (storage module) may be integrated into the processor.

The memory may include, but is not limited to, these memories and any other appropriate type of memory.

FIG. 9 is a diagram of a chip system 30 according to an embodiment. The chip system 30 (which may also be referred to as a processing system) includes a logic circuit 31 and an input/output interface (input/output interface) 32.

The logic circuit 31 may be a processing circuit in the chip system 30. The logic circuit 31 may be coupled and connected to a storage unit, and invoke instructions in the storage unit, to enable the chip system 30 to implement the method and functions in the embodiments. The input/output interface 32 may be an input/output circuit in the chip system 30, and may output information processed by the chip system 30, or input to-be-processed data or signaling information to the chip system 30 for processing.

The chip system 30 is configured to implement operations performed by the terminal device in the foregoing method embodiments.

For example, the logic circuit 31 is configured to implement processing-related operations performed by the terminal device in the foregoing method embodiments, and the input/output interface 32 is configured to implement sending-related and/or receiving-related operations performed by the terminal device in the foregoing method embodiments.

An embodiment further provides a non-transitory computer-readable storage medium. The non-transitory computer-readable storage medium stores computer instructions for implementing the method performed by a device in the foregoing method embodiments.

For example, when the computer instructions are executed by a computer, the computer is enabled to implement the method performed by the terminal device or the network device in the foregoing method embodiments.

An embodiment further provides a computer program product, including instructions. When the instructions are executed by a computer, the method performed by the terminal device or the network device in the foregoing method embodiments is implemented.

An embodiment further provides a communication system, including the foregoing terminal device and network device.

For explanations and beneficial effects of related content in any one of the apparatuses provided above, refer to the corresponding method embodiment provided above. Details are not described herein again.

A person of ordinary skill in the art may be aware that, the units and algorithm steps in the examples described with reference to the embodiments can be implemented by electronic hardware or a combination of computer software and electronic hardware. Whether the functions are performed by hardware or software depends on the embodiments. A person skilled in the art may use different methods to implement the described functions for each embodiment.

For a detailed working process of the foregoing system, apparatus, and unit, refer to a corresponding process in the foregoing method embodiments. Details are not described herein again.

In the several embodiments, the disclosed system, apparatus, and method may be implemented in other embodiments. For example, the described apparatus embodiments may be examples. For example, division into the units may be logical function division and may be other division. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or another form.

The units described as separate parts may or may not be physically separate, and parts displayed as units may or may not be physical units, and may be located in one position, or may be distributed on a plurality of network units. Some or all of the units may be selected according to actual requirements to achieve the objectives of the embodiments.

In addition, functional units in the embodiments may be integrated into one processing unit, each of the units may exist alone physically, or two or more units may be integrated into one unit.

When the functions involve software sold or used as an independent product, the functions may be stored in a non-transitory computer-readable storage medium. Based on such an understanding, the embodiments may be implemented by software. The computer software product is stored in a storage medium, and includes several instructions for enabling a compute device (which may be a personal computer, a server, a network device, or the like) to perform all or some of the steps of the methods described in the embodiments. The foregoing storage medium includes any medium that can store program code, such as a USB flash drive, a removable hard disk, a read-only memory (ROM), a random access memory (RAM), a magnetic disk, or an optical disc.

The foregoing descriptions and embodiments are merely specific implementations, but are not intended as limiting. Any variation or replacement readily figured out by a person skilled shall fall within the scope of embodiments.

1. A method comprising:
receiving a first synchronization signal/physical broadcast channel block (SSB) on a first time-frequency resource; and
receiving a second SSB on a second time-frequency resource, wherein:
the first SSB and the second SSB belong to a first synchronization signal (SS) burst set,
the first time-frequency resource comprises a first time-domain resource and a first frequency-domain resource,
the second time-frequency resource comprises a second time-domain resource and a second frequency-domain resource,
the first time-domain resource is the same as the second time-domain resource, and
the first frequency-domain resource is different from the second frequency-domain resource.

2. The method of claim 1, further comprising:
receiving a third SSB on a third time-frequency resource; and
receiving a fourth SSB on a fourth time-frequency resource, wherein:
the third SSB and the fourth SSB belong to the first SS burst set,
the third time-frequency resource comprises a third time-domain resource and a third frequency-domain resource,
the fourth time-frequency resource comprises a fourth time-domain resource and a fourth frequency-domain resource,
the third time-domain resource is the same as the fourth time-domain resource, and
the third frequency-domain resource is different from the fourth frequency-domain resource.

3. The method of claim 1, wherein the first time-domain resource is a first orthogonal frequency division multiplexing (OFDM) symbol, and the first orthogonal frequency division multiplexing symbol is in a first slot.

4. The method of claim 3, wherein the third time-domain resource is a second OFDM symbol, and the second OFDM symbol is in the first slot.

5. The method of claim 1, wherein:
the first SSB comprises a first physical broadcast channel (PBCH),
the second SSB comprises a second PBCH,
the first PBCH corresponds to a first demodulation reference signal (DMRS) sequence,
the second PBCH corresponds to a second DMRS sequence, and
the first DMRS sequence is the same as the second DMRS sequence.

6. The method of claim 1, wherein;
the first SSB comprises the first physical broadcast channel (PBCH),
the second SSB comprises the second PBCH,
the first PBCH comprises first indication information,
the second PBCH comprises second indication information,
the first indication information indicates the first SSB, and
the second indication information indicates the second SSB.

7. The method of claim 6, wherein;
the first indication information comprises a first index,
the first index indicates the first SSB,
the second indication information comprises a second index, and
the second index indicates the second SSB.

8. The method of claim 7, wherein;
the first indication information is indicated by a first bit in the first PBCH,
the second indication information is indicated by a second bit in the second PBCH,
a value of the first bit is different from a value of the second bit,
the first bit comprises at least one bit, and
the second bit comprises at least one bit.

9. The method of claim 8, wherein:
the first bit is in a first field in the first PBCH,
the second bit is in a second field in the second PBCH,
the first field comprises a choice field or a reserved field of the first PBCH, and
the second field comprises a choice field or a reserved field of the second PBCH.

10. A communication apparatus, comprising:
at least one processor; and
one or more memories coupled to the at least one processor and storing programming instructions for execution by the at least one processor to:
receive a first synchronization signal/physical broadcast channel block (SSB) on a first time-frequency resource; and
receive a second SSB on a second time-frequency resource, wherein:
the first SSB and the second SSB belong to a first synchronization signal (SS) burst set,
the first time-frequency resource comprises a first time-domain resource and a first frequency-domain resource,
the second time-frequency resource comprises a second time-domain resource and a second frequency-domain resource,
the first time-domain resource is the same as the second time-domain resource, and
the first frequency-domain resource is different from the second frequency-domain resource.

11. The communication apparatus of claim 10, wherein the programming instructions are further for execution by the at least one processor to:
receive a third SSB on a third time-frequency resource; and
receive a fourth SSB on a fourth time-frequency resource, wherein:
the third SSB and the fourth SSB belong to the first SS burst set,
the third time-frequency resource comprises a third time-domain resource and a third frequency-domain resource,
the fourth time-frequency resource comprises a fourth time-domain resource and a fourth frequency-domain resource,
the third time-domain resource is the same as the fourth time-domain resource, and
the third frequency-domain resource is different from the fourth frequency-domain resource.

12. The communication apparatus of claim 10, wherein the first time-domain resource is a first orthogonal frequency division multiplexing (OFDM) symbol, and the first orthogonal frequency division multiplexing symbol is in a first slot.

13. The communication apparatus of claim 12, wherein the third time-domain resource is a second OFDM symbol, and the second OFDM symbol is in the first slot.

14. The communication apparatus of claim 10, wherein:
the first SSB comprises a first physical broadcast channel (PBCH),
the second SSB comprises a second PBCH,
the first PBCH corresponds to a first demodulation reference signal (DMRS) sequence,
the second PBCH corresponds to a second DMRS sequence, and
the first DMRS sequence is the same as the second DMRS sequence.

15. The communication apparatus of claim 10, wherein:
the first SSB comprises the first physical broadcast channel (PBCH),
the second SSB comprises the second PBCH, the first PBCH comprises first indication information,
the second PBCH comprises second indication information,
the first indication information indicates the first SSB, and
the second indication information indicates the second SSB.

16. The communication apparatus of claim 15, wherein:
the first indication information comprises a first index,
the first index indicates the first SSB,
the second indication information comprises a second index, and
the second index indicates the second SSB.

17. The communication apparatus of claim 16, wherein:
the first indication information is indicated by a first bit in the first PBCH,
the second indication information is indicated by a second bit in the second PBCH,
a value of the first bit is different from a value of the second bit,
the first bit comprises at least one bit, and
the second bit comprises at least one bit.

18. A communication apparatus, comprising:
at least one processor; and
one or more memories coupled to the at least one processor and storing programming instructions for execution by the at least one processor to:
send a first synchronization signal/physical broadcast channel block (SSB) on a first time-frequency resource; and
send a second SSB on a second time-frequency resource, wherein:
the first SSB and the second SSB belong to a first synchronization signal (SS) burst set,
the first time-frequency resource comprises a first time-domain resource and a first frequency-domain resource,
the second time-frequency resource comprises a second time-domain resource and a second frequency-domain resource,
the first time-domain resource is the same as the second time-domain resource, and
the first frequency-domain resource is different from the second frequency-domain resource.

19. The communication apparatus of claim 18, wherein the programming instructions are further for execution by the at least one processor to:
send a third SSB on a third time-frequency resource; and
send a fourth SSB on a fourth time-frequency resource, wherein:
the third SSB and the fourth SSB belong to the first SS burst set,
the third time-frequency resource comprises a third time-domain resource and a third frequency-domain resource,
the fourth time-frequency resource comprises a fourth time-domain resource and a fourth frequency-domain resource,
the third time-domain resource is the same as the fourth time-domain resource, and
the third frequency-domain resource is different from the fourth frequency-domain resource.

20. The communication apparatus of claim 18, wherein the first time-domain resource is a first orthogonal frequency division multiplexing (OFDM) symbol, and the first OFDM symbol is in a first slot.
